(19) United States
(12) Patent Application Publication
(10) Pub. No.: US 2008/0105066 A1
(43) Pub. Date: May 8, 2008

(54) Split Sample Test Chamber Device

(76) Inventor: Greg Liang, (US)

Correspondence Address: GREG LIANG, 7378 OXFORD PLACE, RANCO CUCAMONGA, CA, 91730, US

(21) Appl. No.: 11/781,248

(22) Filed: Jul. 21, 2007

Related U.S. Application Data
(60) Provisional application No. 60/807,946, filed on Jul. 21, 2006.
(60) Provisional application No. 60/865,573, filed on Nov. 13, 2006.

(51) Int. Cl. G01N 17/00

(52) U.S. Cl. 73/865.6

(57) ABSTRACT

A device for testing a sample solution comprising a test chamber comprising a test component enclosed with air impermeable casing, a sample inlet distal from the test component capable of being connected to a sample solution and, in a test position, maintaining at higher altitude than the liquid level within the test chamber, a sealable air vent distal from the sample inlet capable of permitting air to exit the test chamber when a sample solution flows into the test chamber through the sample inlet and being closed by a sealing means and stopping sample inflow through the sample inlet when sufficient sample solution flows into the test chamber and before the liquid level within the test chamber reaches the level of the sample inlet. The device is useful for testing a portion of a sample solution without contaminating the remaining portion of the sample solution.

This patent application claims priority filing date of U.S. provisional patent application, Jul. 21, 2006, application No. 60/807,946, and of U.S. provisional patent application, Nov. 13, 2006, application No. 60/865,573.

### FIELD OF THE INVENTION

The present invention is related to sample solution testing, particularly related to test devices for testing a portion of a sample solution without contaminating the remaining of the sample solution.

### BACKGROUND OF THE INVENTION

Test cup devices for fluid sample collection and testing limits tester exposure and reserves a portion of the collected fluid sample for re-testing (see, e.g. U.S. Pat. Nos. 6,805,838 and 6,616,893). These test cups are capable of collecting large volumes of specimen, however, the collected specimen is in direct contact with the test component and thus become contaminated by the test component. Such reserved specimens are in many situations considered unsuitable for re-testing. For example, in December 2000, the US Department of Transportation (DOT) released employee drug and alcohol testing rules stating that the original urine sample must be split into two separate containers to allow for retesting—to make sure that the original testing lab did not make an error. U.S. Pat. No. 6,576,193 discloses a test cup device that connects the sample collection reservoir and a test chamber with a valve. In use, the operator manually manipulates the valve to aliquot a portion of the collected sample solution into the test chamber. This device effectively reserves a clean specimen for re-testing. However, the operator is exposed to the risk of contacting the fluid specimen. For a disposable test device, the valve is relatively costly to produce and the valve parts must be precisely made and assembled to prevent sample leakage.

It is useful to have a simpler means for splitting a fluid sample in a test cup device.

### SUMMARY OF THE INVENTION

The present invention is a test chamber device for splitting a test sample solution, and testing a split portion of the sample solution. The test chamber device comprises a test component enclosed by air impermeable walls having a sample inlet, an air vent, and a means for controlling the permeability of the air vent so as to control liquid inflow through the sample inlet. The test chamber is so structured that when, in a test position, a sample solution is permitted through the sample inlet into the test chamber while the displaced air vacates the test chamber through the vent. When the vent is sealed off, the liquid inflow is resisted by the buildup of pressure within the chamber. With the air vent sealed off, liquid exit from the test chamber through the liquid inlet is also resisted due to negative pressure buildup within the chamber. By containing the split sample within the test chamber, the device keeps the test component from contaminating the exterior of the test chamber or the remaining sample solution.

The split sample test chamber is used in combination with a sample container by connecting the sample inlet of the test chamber and the sample solution in the sample container. Such connection is achieved by connecting the sample inlet with the sample container chamber prior or after the sample solution is collected in the sample container. For example, the test chamber can be pre-attached to or constructed in the interior of a cup container or part of a cup container, e.g., a lit of the cup container, or connected to the interior of the cup container through an aperture on the wall or a lid of the cup container.

In a complete split of a test sample, the split sample solutions within and without the test chamber are not in direct contact, thus diffusion of the test component within the test chamber into the sample solution without the test chamber does not occur.

The interior opening of the sample inlet is positioned away from the test component and, when in a test position of the device, e.g., an upright position of a test cup, maintains a higher altitude than the liquid level within the test chamber. The liquid level within the test chamber is controlled by sealing off the air vent before the liquid level reaches the interior opening of the sample inlet. Optionally, an absorbent material within the test chamber is employed to absorb excess sample solution and reduce liquid level inside the test chamber.

The device of the invention is suited for testing sample solutions including, but not limited to, to bodily fluids, environmental water, and liquid extractions of a dry material. Substances in such sample solutions can be detected include, but not limited to, drugs, infectious pathogens, chemicals, antigens, antibodies, and enzymes.

Although rapid absorptive test components, e.g., lateral flow test strips, are common forms of test components used in such devices, other test components, e.g., liquid reagents, reagents in dry powder, granules, or tablets that are readily dissolved by the sample solution may be employed as the test component.

### BRIEF DESCRIPTION OF THE DRAWINGS

FIG. 1 is a perspective view of a device of the invention.

FIG. 2 is a perspective view of the transparent inner layer of the device depicted by FIG. 1.

FIG. 3 is a perspective view of the transparent outer layer of the device also depicted by FIG. 1 and FIG. 2.

FIG. 4 is a perspective view of another embodiment of the invention.

FIG. 5 is a perspective view of a part of the device of FIG. 4.

FIG. 6 is a perspective view of another part of the device of FIG. 4.

### DETAILED DESCRIPTION OF THE DRAWINGS OF THE INVENTION

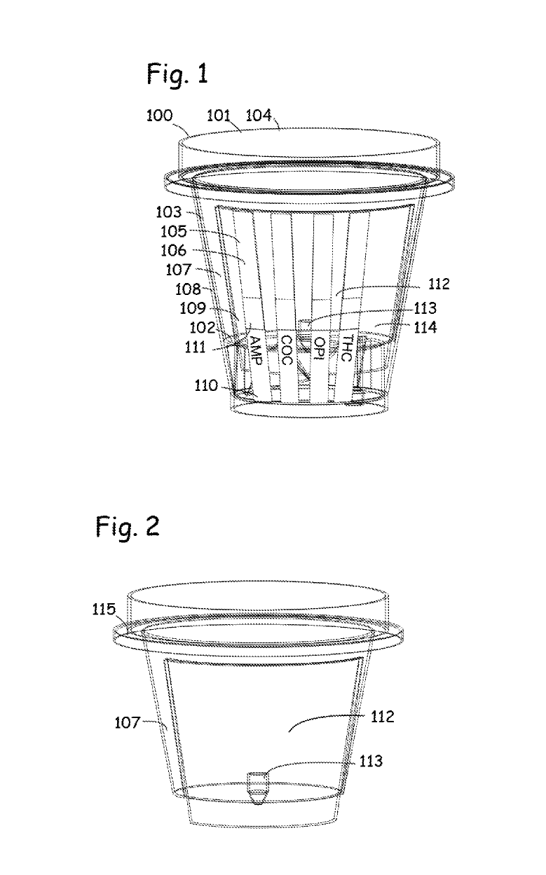

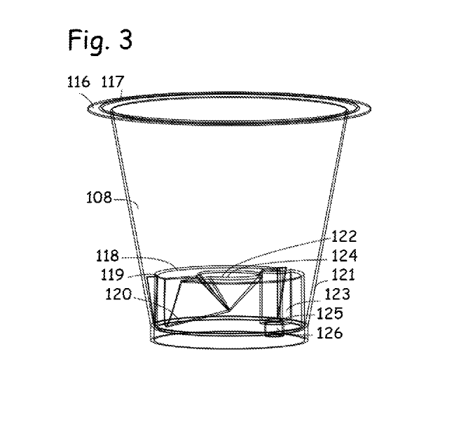

FIG. 1, FIG. 2, and FIG. 3 collectively depict an example test device 100 of the invention, which comprises a split sample test chamber 109 disposed at the bottom 102 and along the side wall 103 of the cup device, comprising a test component 105, liquid inlet 113, and a sealable air vent 125. The sample collection reservoir 101 is defined by the bottom 102, sidewall 103, and the opening 104 opposing the bottom end 102. The device is constructed by binding an inner layer 107 and an outer layer 108 at the rim areas 115 of the inner layer and 116 of the outer layer. The test component 105 comprises lateral flow test strips 106 attached to the test strip backing area 112 of the inner layer of the test chamber walls. The lateral flow test strip comprises a sample addition end 110 and a test area 111. The sample addition end of the lateral flow test strip is disposed towards the bottom of the device. The inner layer has an aperture 113 proximal to the bottom end of the container that permits liquid flow from the reservoir 101 into the test chamber 109. The test area 111 of the test strip is visible from the outside of the device through a transparent window 114. The bottom 118 of the outer layer 108 comprises an inwardly protruding section 119 forming a curvy space 120 between the protruding section 119 and the side wall 121. At the first end 122 of the curvy space is a fluid receiving port 124 capable of receiving the fluid released from the container reservoir through the aperture 113. Disposed at the second end 123 of the curvy space is an air vent 125 disposed on the bottom of the outer layer and filled with a porous plug 126. In an assembled test device the curvy space 120 constitutes the lower section of the test chamber. The porous plug 126 permits air to flow through and will lose permeability to air or liquid when it is wetted by a sample solution. Such hydraulic seal function of the porous plug can be achieved by controlling the pore size of the plug material, or by incorporating a solid material that becomes viscous when moisturized in a porous material.

The test strips are attached to the inner layer side wall by an attaching means, e.g., gluing or taping. With the test component attached to the inner layer sidewall, the inner layer and the outer layer are coupled to each other by connecting at the rim areas 115 of the inner layer and 116 of the outer layer. A sealing line 117 is disposed at the outer layer rim on the side proximal to the opening. When the two layers are bound together, the sealing line warrants a tight seal between the two layers. Means for binding the two layers include gluing and high frequency welding, which are known to those familiar in such fields.

When a sample solution is collected in the test cup, a volume of the sample flows through the inlet 113 into the test chamber 109 while the displaced air exits the test chamber through the air vent. Upon contact, the test solution inside the test chamber will migrate along the test strip to the test area 111, where the test solution reacts with the assay reagents and produces a test signal readable through window 114. The sample flow will reach the air vent area, moisturizes the porous plug, and seals off the air vent before the liquid level within the test chamber reaches the level of the sample inlet 113.

Other means to seal off the air vent include but not limited to a rubber or plastic plug, or an adhesion tape.

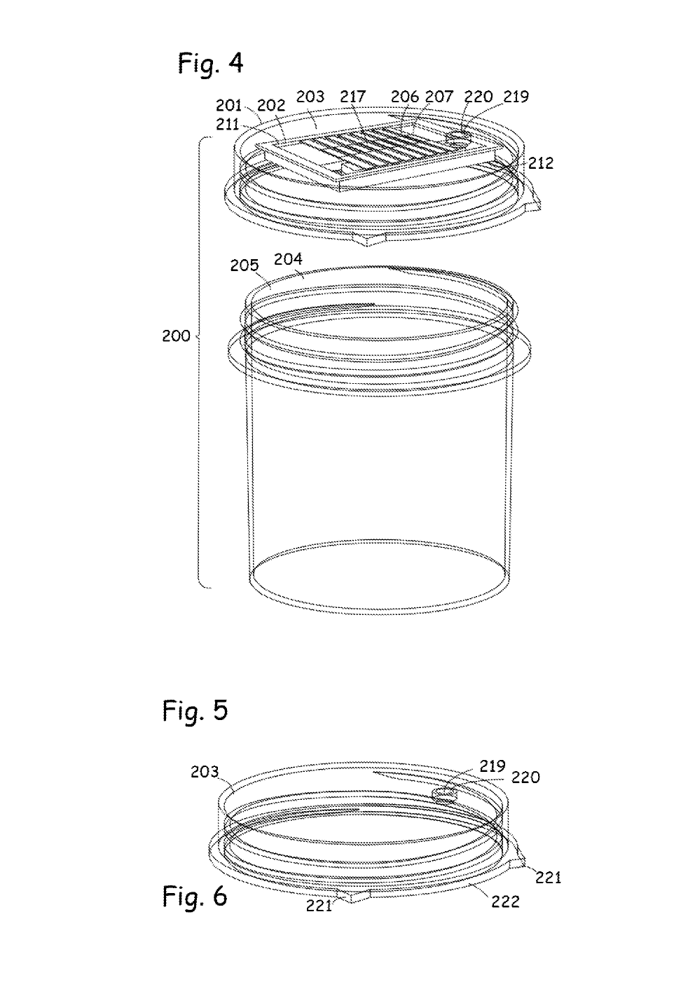

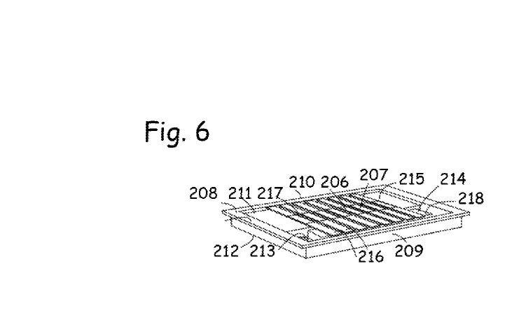

FIG. 4, in conjunction with FIG. 5 and FIG. 6 depicts another test chamber device 200 of the invention. Device 200 is a urine test cup device comprising a cup lid assembly 201 comprising a split sample test chamber 202 constructed to a transparent lid part 203. The lid assembly is capable of covering the opening 204 of sample collection cup 205. The test chamber 202 comprises a test component 206 comprising lateral flow test strips 207 enclosed by a plastic base part 208 shaped to form the test chamber when bound to the interior side of the center 208 of the lid part 203. The test chamber comprises a front end 209, a back end 210, an upper side 211, and a lower side 212, a sample inlet 213 and longitudinal space 214 proximal to the lower side of the front end, an air vent 219 filled with a hydraulic sealing air vent plug 220 disposed at the upper side of the front end in contact with the absorbent member 218, and an elevated test component support area 215 proximal to the back end. The lateral flow test strip 207 comprises a sample addition end 216 and a test area 217. The sample addition end 216 of the test strip is disposed towards the front end 209 in fluid connection with a longitudinal absorbent member 218 disposed in the longitudinal space 214. Two legs 221 protruding horizontally from the rim 222 of the lid assembly are disposed at the front end direction of the test chamber. When the lid assembly is applied to the sample collection cup and tilted sideways, the legs 220 supports and orients the test device in the test position, i.e., with the front end of the test chamber oriented below the back end of the test chamber.

When a sample solution is collected in the sample collection cup 205, the lid assembly 201 is securely placed to the opening 204 of the cup and tiled towards the front end of the test chamber to submerge the lower side of the front end of the test chamber in the sample solution. Consequently, the sample solution flows through the sample inlet into the test chamber. The sample solution is absorbed by the longitudinal absorbent member and the sample addition end of the test strips. When the porous plug 220 is moisturized by the sample solution of the absorbent member 218, the air is vent 209 shuts off. Liquid inflow at the sample inlet 211 is resisted. The majority of the sample solution within the test chamber is absorbed by the absorbent member and the lateral test strips. Therefore, liquid outflow from the test chamber or component diffusion into the sample solution in the sample collection cup will not occur.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Unless defined otherwise, all technical and scientific terms used herein have the same meanings as commonly understood by one of ordinary skill in the art to which this invention belongs. Although any methods and systems similar or equivalent to those described herein can be used in the practice or testing of the present invention, the methods, devices, and materials are now described. All publications mentioned herein are incorporated herein by reference for the purpose of describing and disclosing the processes, systems, and methodologies, which are reported in the publications which might be used in connection with the invention. Nothing herein is to be construed as an admission that the invention is not entitled to antedate such disclosure by virtue of prior invention.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions, which have been employed, are used as terms of description and not of limitation, equivalents of the features shown and described, or portions thereof, are not excluded, and it is recognized that various modifications are possible within the scope of the invention. Embodiments of the invention are set forth in the following claims.

I claim:

1. A device for testing a sample solution comprising a test chamber comprising a test component enclosed by an air impermeable casing, a sample inlet distal from the test component capable of being connected to a sample solution and, in a test position, maintaining a higher altitude than the liquid level within the test chamber, a sealable air vent distal from the sample inlet capable of permitting air to exit the test chamber when a sample solution flows into the test chamber through the sample inlet and being closed by a sealing means and stopping sample inflow through the sample inlet when sufficient sample solution flows into the test chamber and before the liquid level within the test chamber reaches the level of the sample inlet.

2. The device of claim 1, wherein the sample solution is a sample from a group of solutions including, but not limited, to bodily fluid, environmental water, and liquid extraction of a dry material.

3. The device of claim 1, wherein the test component is a lateral flow test strip for testing substances including, but not limited to, drugs, infectious pathogens, chemicals, antigens, antibodies, and enzymes.

4. The device of claim 1, wherein the test component is a lateral flow test strip.

5. The device of claim 1, wherein the sealing means is a capillary porous plug permeable to air in dry condition and becomes non permeable when moisturized by a sample solution.

6. A test device for collecting and testing a sample solution comprising a sample collection cup, a lid capable of covering the sample collection cup defined by a bottom, sidewalls, and an opening, and a test chamber comprising a test chamber comprising a test component enclosed by an air impermeable casing, a sample inlet distal from the test component capable of being connected to a sample solution and, in a test position, maintaining a higher altitude than the liquid level within the test chamber, a sealable air vent distal from the sample inlet capable of permitting air to exit the test chamber when a sample solution flows into the test chamber through the sample inlet and being closed by a sealing means and stopping sample inflow through the sample inlet when sufficient sample solution flows into the test chamber and before the liquid level within the test chamber reaches the level of the sample inlet.

7. The test device of claim 6, wherein the sample inlet is disposed at the bottom of the sample collection cup.

8. The test device of claim 6, wherein the test chamber is disposed at the lid of the device.

9. A method for testing a sample solution comprising introducing a sample solution into device comprising a test chamber comprising a test component enclosed by an air impermeable casing, a sample inlet distal from the test component capable of being connected to a sample solution and, in a test position, maintaining a higher altitude than the liquid level within the test chamber, a sealable air vent distal from the sample inlet capable of permitting air to exit the test chamber when a sample solution flows into the test chamber through the sample inlet and being closed by a sealing means and stopping sample inflow through the sample inlet when sufficient sample solution flows into the test chamber and before the liquid level within the test chamber reaches the level of the sample inlet.
